(19) United States
(12) Patent Application Publication
(10) Pub. No.: US 2006/0209886 A1
(43) Pub. Date: Sep. 21, 2006

(54) Small form-factor device implementing protocol conversion

(75) Inventors: Hugo Silberman, Kfar Sirkin (IL); Yaakov Stein, Jerusalem (IL)

Correspondence Address: GOTTLIEB RACKMAN & REISMAN PC, 270 MADISON AVENUE, 8TH FLOOR, NEW YORK, NY, 100160601, US

(73) Assignee: RAD Data Communications, Ltd., Tel Aviv (IL)

(21) Appl. No.: 11/072,349

(22) Filed: Mar. 4, 2005

(51) Int. Cl. H04J 3/16; H04J 3/22

(52) U.S. Cl. 370/466

(57) ABSTRACT

A small form-factor transceiver module performs protocol translation, in addition to the conventional electrical and/or optical transmission media conversion. Such protocol conversion may enable transport of traffic from limited-range primary networks over long-range secondary networks, such as extension of Ethernet networks over low-rate TDM links. Additionally, such protocol conversion may enable interworking between different networks of differing technologies, such as transport of ATM traffic over Ethernet networks. The transceiver module may be a Small Form Factor transceiver (SFF), Small Form Factor pluggable module (SFP), Gigabit Interface Converter (GBIC) or any similar small form-factor module consisting of a housing, internal electronic circuitry and optionally optical components, and associated electrical or optical connectors. The transceiver module performs protocol translation by means of an integral protocol translation unit that performs standards-based or proprietary conversion between network protocols.

### RELATED APPLICATIONS

None

### FIELD OF THE INVENTION

The present invention relates generally to the field of digital communications networks such as Ethernet, ATM, SONET/SDH, IP, MPLS, and low-rate TDM networks, in particular to the facilitating of interconnection of such networks. More specifically, the invention consists of a small form-factor device that enables standards-based or proprietary interworking between different network types, such as the transport of Ethernet frames, IP packets or ATM cells over TDM links, or the transport of ATM or TDM traffic over Ethernet, IP or MPLS networks.

### BACKGROUND OF THE INVENTION

With the explosive increase in data rates of backbone networks, edge switches need to feed increasing numbers of tributary networks, and hence need more and more ports. For example, 10 Mbit/s Ethernet hubs commonly had only 4 or 8 ports, while Gigabit Ethernet (GbE—IEEE 802.3z) switches often have 48 or 60 ports. For this reason the physical interfaces, including electrical and/or optical circuitry and connectors, need to be miniaturized.

Small form-factor modules have become extremely popular interface devices due to their small physical dimensions and low power consumption. Several such modules types have been standardized by the industry, including Small Form Factor (SFF), Small Form Factor Pluggable (SFP), and Gigabit Interface Converter (GBIC) modules. These all consist of a housing, internal electronic circuitry and optionally optical components, along with associated electrical or optical connectors.

In addition to not requiring additional shelf space, such transceiver modules have the additional advantage of having very low power consumption, and of obtaining their power from the switch to which they connect. This alleviates power delivery wiring complications.

When such modules are used to provide bidirectional interconnection between different 5 network technologies, they are called transceiver modules. Electrical transceiver modules interconnect two electrical networks, while when one of the network is based on fiber-optics the converter is usually called an electro-optical transceiver module.

SFF and SFP modules are finger-sized (about half the width of the earlier GBIC technology modules), and conform to an industry Multi-Source Agreement (MSA). The physical size of SFF/SFP modules facilitates maximal port density consistent with conventional connectors. The difference between the SFF and SFP lies in the SFF being permanently connected to the switch, while the SFP is a pluggable, hot-swappable, interface that may be replaced or exchanged as required.

The SFF and SFP devices that have been widely deployed allow interconnection of a high-rate primary network (e.g. Gigabit Ethernet) with a secondary network or link of the same or lower rate (e.g. 100 Mbit/s Ethernet). The SFF or SFP is located in a switch at the edge of the primary network, and its electrical or optical connector feeds the secondary network or link. Large numbers of tributaries may be connected to a high-rate network by densely packing SFF or SFP modules on the switch front panel. Each SFF or SFP module performs physical layer format conversion, converting between the electrical format of the primary network and the electrical or optical format of the secondary networks or links.

Small form-factor devices may be found on Ethernet switches, IP or MPLS routers, ATM switches, and SONET/SDH devices such as add and drop multiplexers (ADMs). As such the lower layers of the primary network may consist of Ethernet, ATM or Optical networks such as OC-3 (155 Mbit/s)/OC-12(622 Mbit/s). Similarly, the lower layers of the secondary network or link are typically TDM, Ethernet or ATM.

Ethernet networks, having been originally designed as Local Area Networks (LANs), are severely limited in physical extent. Traditional Ethernet was limited to 100-meter spans, and while later extensions, such as Ethernet in the First Mile (EFM), have increased this limit, Ethernet is still most frequently used as a LAN technology, with other technologies providing the wide area network (WAN) components.

When Ethernet LANs are physically remote from each other they can be interconnected by transporting Ethernet frames over long-range transport technologies, such as TDM networks. For example, to support high data rates, Ethernet frames may be carried over SONET/SDH infrastructure by using the Generic Framing Procedure (GFP—ITU-T Recommendation G.7041/Y.1303), and greater flexibility and bandwidth efficiency is attained when augmenting this approach with Virtual Concatenation (VC—ITU-T Recommendation G.707). In addition, Ethernet frames may be carried over SONET/SDH links using the Packet Over SONET (POS) encapsulation, specified in IETF RF 2615.

When lower data rates are sufficient for the traffic to be transported, Ethernet frames may be transported over T1 (1.544 Mbit/s), E1 (2.048 Mbit/s), T3 (44.736 Mbit/s) or E3 (34.368 Mbit/s) links. This can be accomplished by encoding the Ethernet frames using the High-level Datalink Control Protocol (HDLC—ISO/IEC 3309, IETF RFC 1662), Ethernet over Link Access Protocol—SDH (LAPS—ITU-T Recommendation X.86/Y.1323), or GFP. Despite its name, X.86/Y.1323 is directly applicable as it describes the mapping of an Ethernet frame into a continuous stream of octets, but does not describe the mapping of this bit-stream into SDH. Recent ITU-T Recommendation G.7043/Y.1343 describes the virtual concatenation of low-rate TDM signals and G.8040/Y.1340 describes the mapping of GFP frames into such virtually concatenated TDM signals.

The present invention addresses this need, and specifies small form-factor modules that enable transport of Ethernet frames over low-rate TDM links where it would be difficult or expensive to do so by conventional means.

FIG. 1 illustrates physical configuration of the small form-factor transceiver module 100. The module consists of a housing 101, an internal connector 102 for connection to the primary network, a printed circuit board (PCB) 103 containing all the required protocol and transmission medium conversion circuitry, and an external connector 104 for connection to the secondary network or link.

FIG. 2 depicts a simplified block diagram of the small form-factor transceiver module 200 for transport of Ethernet traffic over a TDM link. The main blocks are the internal connector 202, and external connector 203, the Ethernet PHY 210 with its crystal oscillator 211, the protocol translation logic 220, the TDM PHY 230 with its TDM crystal oscillator 231 and TDM protection circuitry. The internal connector 202 connects to the primary Ethernet network, while the external connector 203 connects to the secondary TDM network or link.

FIG. 3a illustrates protocol translation for the case of packet- or frame-based traffic transported by a serial protocol link, such as TDM. When there are no packets the serial oriented protocol consists of idle indicator 301. When a data packet arrives, the protocol translator outputs a start flag 302 followed by the content of the data packet 303. This content may first be adapted for example by, removing un-needed headers or replacing occurrences of data patterns that may be mis-interpreted as idle indicators with another data pattern.

The scope of the applicability of the present invention is not limited to transport of Ethernet frames over low-rate TDM links. One versed in the art will readily appreciate that this invention can be extended to any limited-range network over any link or network with the desired physical range. Indeed it is not even required for the primary packet-oriented network to be extended over the secondary serial/TDM link; rather it may be the case that the TDM link is required to be extended over the primary packet-oriented network.

FIG. 3b illustrates the protocol translation for the case wherein serial traffic such as TDM 310 is to be transported by a packet or frame oriented protocol. The TDM bit stream is first segmented and then the resulting segments 312 are encapsulated by prepending packet headers 311. The TDM segments 312 may first be adapted in order to aid in recovery of the source TDM clock frequency, and to help conceal the effects of packet loss.

Protocol translation is useful in contexts other than extension of limited-range networks. For historical reasons a large number of different data communications technologies presently exist and are widely deployed. Technology disparities limit a user's choice of transport means and present barriers to communications between users served by network of dissimilar technologies.

In order to overcome these two constraints, two generic forms of “interworking”, that is interconnection between networks of disparate technologies, have been developed. Network interworking (also known as client-server interworking) enables tunneling of traffic of one technology through a transport network of a second technology. When the transport network is packet-switched network, this can be accomplished by encapsulating the entire protocol content of the first network (payload data and protocol overhead) in packets of the second network. At the other end of the transport network the packet is decapsulated, revealing the original protocol content. When such a tunnel is so used to emulate a native technology it is often called a pseudowire (PW), since from the points of view of the end-users the tunnel seems to be a bare wire.

Service interworking (also known as peer-to-peer interworking) enables interchange of data between end networks of disparate technologies. In such cases the first network protocol is terminated, that is the protocol overhead removed and the payload data then encapsulated in packets of the second network protocol by adding new protocol overhead.

FIG. 3c illustrates network interworking (client-server interworking) between two packet-oriented protocols. The entire packet of the client protocol, consisting of the packet headers 312 and payload 322, becomes the payload 324 for the server protocol that encapsulates it by adding its own packet headers 323.

FIG. 3d illustrates service interworking (peer-peer interworking) between two packet oriented protocols. The packet headers 325 of one protocol are replaced by those of second protocol 327, while the payload 326 is carried intact.

Both network interworking and service interworking can be implemented by appropriate protocol translation logic in a small form-factor module. Service interworking entails a small form-factor module with protocol translation unit that terminates the secondary network protocol and transfers the payload data to the format of the primary network protocol, and vice versa.

Network interworking can be realized by two network elements, such as Ethernet or ATM switches, on the same primary network. Each of these network elements contains small form-factor modules that interface to the same secondary protocol. The small form-factor modules encapsulate the entire protocol content of the secondary networks and enable tunneling of this content across the primary network infrastructure.

A number of pseudowire protocols have been standardized by the IETF and ITU-T. For instance, the ITU-T has standardized tunneling over MPLS networks of ATM (Y.1411 and Y.1412), of frame-relay (X.84), of low-rate TDM (Y.1413), and of Ethernet (Y.1415).

The scope of the applicability of the present invention is not limited to transport of ATM, frame-relay, low-rate TDM and Ethernet over MPLS networks. One versed in the art could readily extend this invention to the transport over Ethernet, IP, ATM or SDH primary networks, and to the transport of other protocols over MPLS or these aforementioned networks.

As will subsequently become apparent, the essential defining feature of the present invention is the capability of performing protocol format translation in a small form-factor module.

U.S. Pat. No. 6,179,627 to Daly et al. describes a small form-factor pluggable high-speed interface converter module for converting data signals from a first transmission medium to a second transmission medium. It teaches the physical and electrical aspects of such a device, including details of the housing, connectors, releasable latch, and guide tabs. It further teaches how to prevent spurious electromagnetic emissions by appropriate shielding. However, Daly et al does not teach the use of such interface modules for low-rate TDM links, rather they specifically limit the scope of their invention to high rate networks, such as GbE. Furthermore, Daly et al does not teach protocol translation in such a device.

U.S. Pat. No. 6,731,510 to Hwang et al. describes a small form-factor pluggable with an RJ connector. It teaches the provision of an RJ connector for use with an SFP module, and the use of a reinforced structure that strengthens the connection between said RJ connector and the rest of the SFP module. As RJ connectors are frequently used for low-rate TDM (as well as 10BaseT Ethernet), this invention would be complementary to an invention enabling the interconnection of low-rate TDM with high-rate networks via SFP modules. However, Hwang et al is silent as to the use of the RJ connector it proposes, and in particular does not specify its use for low-rate TDM. Furthermore, Hwang et al does not teach protocol translation in such a device.

U.S. Pat. Nos. 6,705,879 to Engel et al. describes a small form-factor transceiver module that may be plugged into a switch or other network device. The transceiver consists of transceiver electronics implemented on a printed circuit board sized to fit within the switch port cage, and an RJ connector that extends outside of the port cage. Engel et al teaches the implementation of a small form-factor transceiver for interconnection of networks using electronic and magnetic circuitry. However, Engel et al does not teach the use of such transceiver modules for low-rate TDM links. Furthermore, Engel et al does not teach protocol translation in such a device.

Whatever the precise merits, features and advantages of the above inventions, they do not achieve or fulfill the purposes of the present invention.

### SUMMARY OF THE INVENTION

The present invention is a small form-factor transceiver module that provides protocol translation in addition to conventional conversion between electrical and/or optical transmission media. Such protocol conversion may enable transport of traffic from limited-range primary networks over long-range secondary networks, such as extension of Ethernet networks over low-rate TDM links. Additionally, such protocol conversion may enable network and service interworking between different networks of differing technologies, such as transport of ATM or frame-relay traffic over MPLS networks.

The small form-factor transceiver module consists of a housing, internal electronic circuitry and optionally optical components, along with associated electrical or optical connectors, and will usually conform to industry standards, e.g. SFF, SFP or GBIC modules. The protocol translation may be standards-based or proprietary.

In particular, the present invention enables transport of Ethernet frames over n*64K serial links, T1, E1, fractional T1, fractional E1, T3, E3, and 155/622 Mbit/s SONET/SDH or ATM links; the transport of TDM over Ethernet, IP, MPLS and ATM networks; and ATM or frame-relay over Ethernet or MPLS networks. Furthermore, the present invention enables transport of Ethernet over MPLS networks and supports the building of Virtual Private LAN Services.

### BRIEF DESCRIPTION OF THE DRAWINGS

FIG. 1 illustrates physical configuration of the small form-factor transceiver module implementing protocol translation.

FIG. 2 depicts a simplified block diagram of the transceiver module for the first embodiment wherein Ethernet traffic is transported over a TDM link.

FIG. 3a illustrates protocol translation for the case of packet- or frame-based traffic transported by a serial protocol link, such as TDM.

FIG. 3b illustrates the protocol translation for the opposite case, wherein serial traffic such as TDM is to be transported by a packet or frame oriented protocol.

FIG. 3c illustrates network interworking (client-server interworking) between two packet-oriented protocols.

FIG. 3d illustrates service interworking (peer-peer interworking) between two packet oriented protocols.

FIG. 4a depicts the use of a small form-factor module with protocol translation to extend Ethernet over a TDM link.

FIG. 4b depicts the use of a small form-factor module with protocol translation to transport TDM over an Ethernet network.

FIG. 4c depicts the use of a small form-factor module with protocol translation for the transport of ATM over an MPLS network (ATM pseudowire).

FIG. 4d depicts the use of a small form-factor module with protocol translation for the transport of Ethernet over a TDM network.

FIG. 4e depicts the use of a small form-factor module with protocol translation for transport of Ethernet over an ATM network (service interworking).

FIG. 4f depicts the use of a small form-factor module with protocol translation for transport of TDM over an ATM network.

FIG. 4g depicts the use of a small form-factor module with protocol translation for transport of Ethernet over an MPLS network (Ethernet pseudowire).

FIG. 4h depicts a Virtual Private LAN Service (VPLS) supported by small form-factor modules.

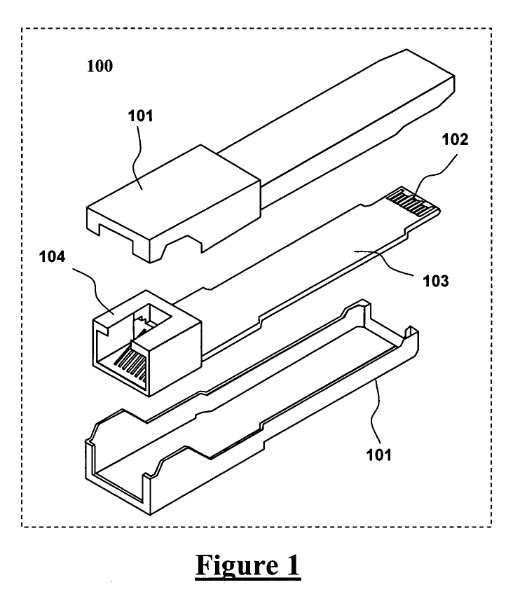

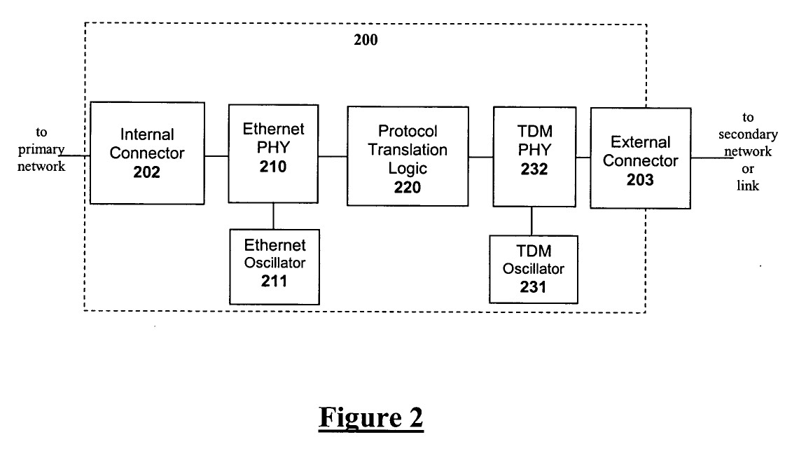

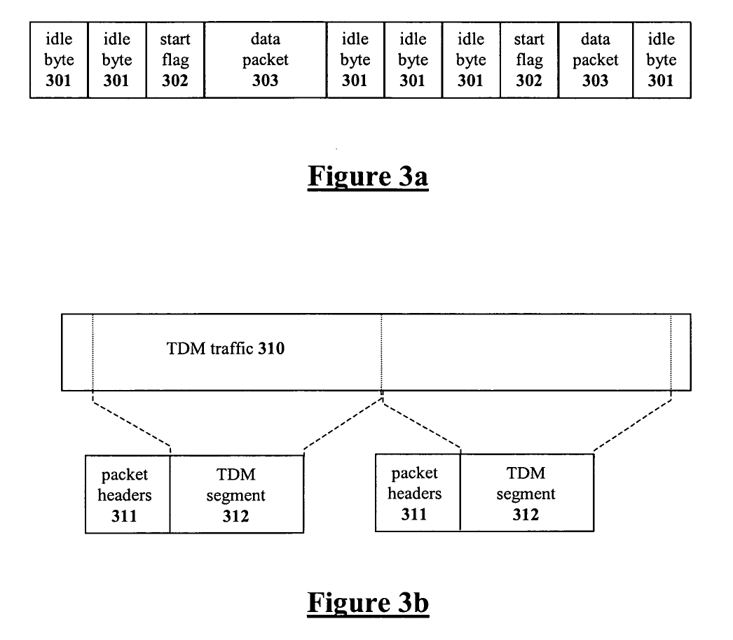

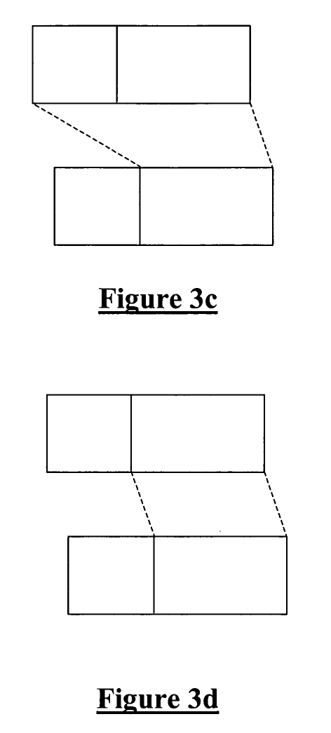

### DETAILED DESCRIPTION OF THE PREFERRED EMBODIMENTS

As has been previous stated, the invention may be instantiated in any small form-factor module, such as SFF, SFP, GBIC, etc. The high-rate network will usually be Ethernet at 100 Mbit/s or 1 Gbit/s, SONET/SDH at 155 or 622, or ATM at these same rates, but may be at other rates or may consist of any high-rate packet-oriented or frame-oriented network. The low-rate TDM link will usually be T1, E1, T3 or E3, but may be any synchronous serial digital network of appropriate rate.

In a first embodiment Ethernet frames are transported for long distances over a TDM link or network. A small form-factor transceiver module is connected to a suitable port of a standard Ethernet (such as 10 Mbit/s, 100 Mbit/s, or 1 Gbit/s Ethernet) switch connected to a first Ethernet network. Inside the small form-factor module the Ethernet frames are encoded using HDLC, Ethernet over LAPS, or GFP into a framed or unframed T1 or E1 bit-stream. This bit-stream is then encoded using an appropriate line code (e.g. AMI, B8ZS, HDB3) to produce a TDM physical layer signal that is applied to twisted-pair or coaxial cable via an appropriate connector on the exposed side of the small form-factor module. The twisted-pair or coaxial cable connected to the connector on the small form-factor module forms the secondary link. This cable may run for a long distance (e.g. 3000 feet for AMI) and may be extended further by employing repeaters or DSL modems. At its other end, the cable connects to a second small form-factor transceiver module is connected to a switch connected to a second Ethernet network. By exploiting standard Ethernet switch functionality, the two Ethernet networks have been interconnected, subject only to the bandwidth restriction imposed by the secondary low-rate TDM link.

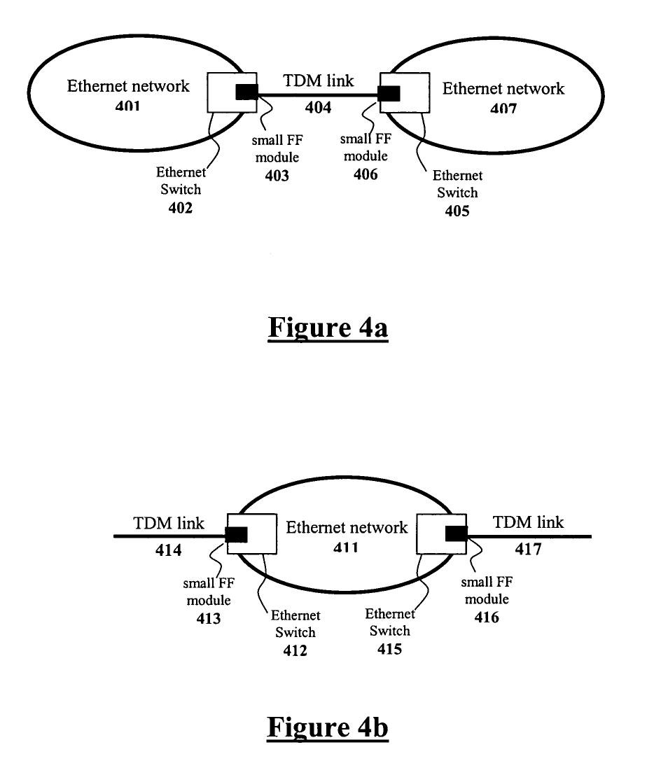

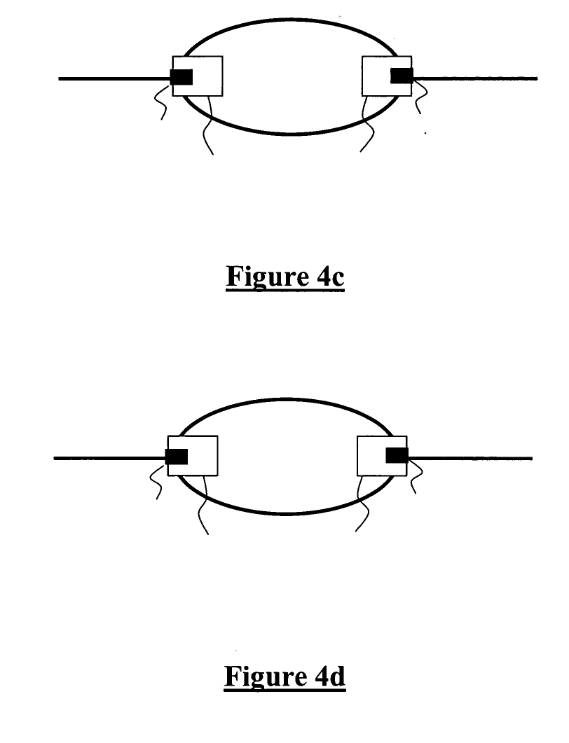

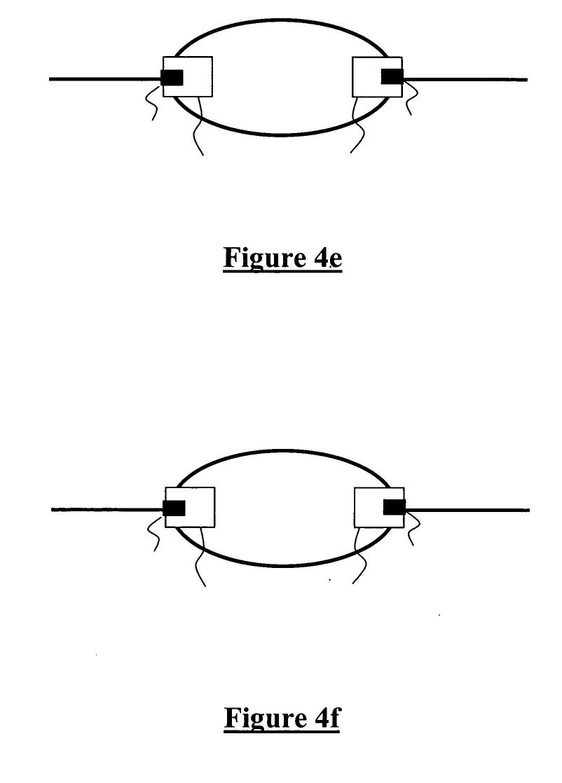

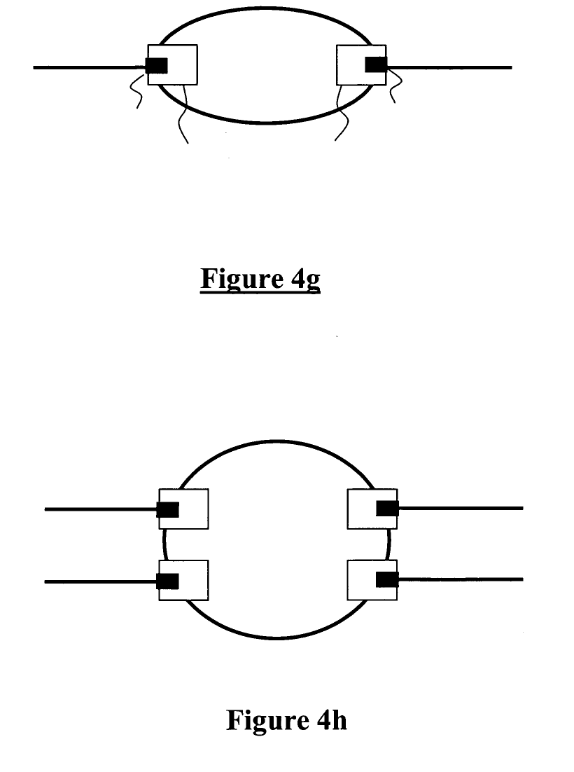

FIG. 4a depicts the use of a small form-factor module with protocol translation to extend Ethernet over a TDM link. A first Ethernet switch 402 is connected to a first Ethernet network 401. A small form factor module 403 in Ethernet switch 402 interconnects Ethernet network 401 and TDM link 404. At the far end of TDM link 404 a second small form-factor module 406 in Ethernet switch 405 interconnects the TDM link 404 with a second Ethernet network 407.

In a variation of this embodiment, the T1 or E1 signals may themselves be transported using higher rate PDH or SONET/SDH infrastructures, thus eliminating all distance restrictions without need for T1/E1 repeaters. In this case the PDH or SONET/SDH networks function as a secondary network, enabling interconnection of two primary Ethernet networks. By exploiting the Public Switched Telephony Network (PSTN) the two Ethernet networks being connected may then be located anywhere in the world.

In yet another variation of the first embodiment, the first and second small form-factor modules may be equipped with coaxial cable connectors, and encode the Ethernet frames over unframed T3 or E3 digital signals. This enables utilization of the larger data-rates supported by these PDH signals.

In yet another variation of the first embodiment, the small form-factor modules may be electro-optical transceivers. They then have fiber-optic connectors (e.g. LC, ST, SC or FC-type) and connect to fiber-optic cables. This can potentially significantly extend the range of the low-rate TDM, e.g. to 100 km.

In a second embodiment T1 or E1 TDM traffic is transported across an Ethernet network, which may additionally have IP or MPLS higher layers. A first small form-factor transceiver module is plugged into a suitable port of a first Ethernet switch connected to a primary Ethernet network, and a second small form-factor transceiver module is plugged into a suitable port of a second Ethernet switch Ethernet switch connected to the same primary Ethernet network. The small form-factor modules are equipped with RJ or BNC connectors to which T1 or E1 TDM signals are applied. Accordingly, both small form-factor modules encapsulate TDM signals into Ethernet frames, e.g. according to ITU-T Recommendation Y.1413 for MPLS, or according to one of the IETF methods Structure Agnostic TDM over Packet (SAToP), TDM over IP (TDMoIP) or Circuit Emulation Service over Packet Switched Network (CESoPSN) for UDP/IP, or according to Metro Ethernet Forum (MEF) Implementation Agreement 8 for raw layer 2 Ethernet. Similarly, both small form-factor modules decapsulate Ethernet frames and reconstitute TDM signals according to the aforementioned standards. In this fashion T1 or E1 TDM traffic may be transported over an Ethernet, IP or MPLS packet switched network.

FIG. 4b depicts the use of a small form-factor module with protocol translation to transport TDM over an Ethernet network. A first small form-factor module 413 in Ethernet switch 412 is connected to a first TDM link 414. At the other end of the primary Ethernet network 411 is a second Ethernet switch 415 in which is a second small form factor module 416 feeding a second TDM link 417.

In a variation of the second embodiment, the TDM signals may be T3 or E3 signals PDH signals applied to BNC connectors on the small form-factor modules. These modules encapsulate and decapsulate the PDH signals using the aforementioned standards in order to enable their transport over a packet switched network.

In yet another variation of the second embodiment, the TDM signals may be SONET/SDH signals applied to fiber-optic connectors on the small form-factor modules. These modules encapsulate and decapsulate the SONET/SDH signals according to Circuit Emulation over Packet (CEP), as defined by the IETF.

In a third embodiment ATM traffic is transported across an MPLS network. A first small form-factor transceiver module is plugged into a suitable port of a first MPLS Label Switched Router (LSR) connected to an MPLS network, and a second small form-factor transceiver module is plugged into a suitable port of a second LSR connected to the same MPLS network. Both small form-factor modules receive ATM traffic in any of the physical formats in which ATM may be delivered (including fiber-optic, copper, or ATM carried over TDM links). The ATM cells are extracted from whatever physical layer over which they are provided, and encapsulated according to either of ITU-T Recommendations Y.1411 or Y.1412 or similar ATM pseudowire specifications for tunneling across the MPLS network.

FIG. 4c depicts the use of a small form-factor module with protocol translation for the transport of ATM over an MPLS network (ATM pseudowire). A first small form-factor module 423 in a first MPLS Label Switched Router (LSR) 422 encapsulates ATM cells from a first ATM link 424 and tunnels them across MPLS network 412. At a second LSR 425 a second small form-factor module 426 decapsulates the MPLS packet, retrieving ATM cells that are sent to a second ATM link 427.

In a variation of the third embodiment, instead of ATM links we may have frame-relay ones. The frames are then extracted from whatever physical layer over which they are provided, and encapsulated according to ITU-T Recommendations X.84 or similar frame-relay pseudowire specifications for tunneling across the MPLS network.

In a fourth embodiment Ethernet frames are transported for long distances over a TDM network, as in the first embodiment, only here the TDM network is the primary network and the Ethernet is the secondary link. A first small form-factor transceiver module is connected to a tributary port of a first TDM add and drop multiplexer (ADM), and a second small form-factor transceiver module is connected to a tributary port of a second ADM on the same TDM network. The modules have either RJ or fiber-optic (LC, ST, SC or FC-type) external connectors for connection of Ethernet (e.g. 10 Mbps or 100 Mbps Ethernet) cables. The protocol conversion may be as in the first embodiment into a T1 or E1 bit stream that may then be placed in a suitable virtual container for transport over SONET/SDH, or may be using Ethernet over SONET (EoS) according to ITU-T Recommendation X.86/Y.1323. In this fashion two Ethernet local area networks (LANs) may be connected over the TDM network.

FIG. 4d depicts the use of a small form-factor module with protocol translation for the transport of Ethernet over a TDM network. A first small form-factor module 433 in a first TDM device, e.g. a SONET/SDH Add and Drop Multiplexer (ADM) 432 receives Ethernet frames from a first Ethernet link 434 and forwards them across TDM network 431. At a second ADM 435 a second small form-factor module 436, retrieves Ethernet frames that are sent to a second Ethernet link 437.

In a fifth embodiment Ethernet frames are transported for long distances over an ATM network. A first small form-factor transceiver module is connected to a port of a first ATM switch, and a second small form-factor transceiver module is connected to a port of a second ATM switch. The modules have either RJ or fiber-optic (LC, ST, SC or FC-type) external connectors for connection of a 10 Mbit/s, 100 Mbit/s, or Gbit/s Ethernet cables. The protocol conversion is according to ATM Adaptation Layer Type 5 (AAL5) as described in ITU-T Recommendation I.363.5. This embodiment will probably be constrained in some way due to memory requirements of such an implementation.

FIG. 4e depicts the use of a small form-factor module with protocol translation for transport of Ethernet over an ATM network (service interworking). A first small form-factor module 443 in a first ATM switch 442 receives Ethernet frames from a first Ethernet link 444, terminates the Ethernet layer, uses AAL type 5 to adapts the payload into ATM cells that are forwarded across ATM network 441. At a second ATM switch 445 a second small form-factor module 446 terminates the ATM layer and reconstitutes Ethernet frames that are sent to a second Ethernet link 447.

In a sixth embodiment TDM traffic is carried over an ATM network. A first small form-factor transceiver module is connected to a port of a first ATM switch, and a second small form-factor transceiver module is connected to a port of a second ATM switch. The modules have either RJ or BNC external connectors for connection of T1, E1, T3 or E3 TDM signals. The protocol conversion may be according to ATM Adaptation Layer Type 1 (AAL1) as described in ITU-T Recommendation I.363.1. For channelized T1 or E1 the protocol conversion may alternatively be according to ATM Adaptation Layer Type 2 (AAL2) as described in ITU-T Recommendation 1.363.2.

FIG. 4f depicts the use of a small form-factor module with protocol translation for transport of TDM over an ATM network. A first small form-factor module 453 in a first ATM switch 452 receives a TDM bit-stream from a first TDM link 454, uses AAL type 1 or 2 to adapts the payload into ATM cells that are forwarded across ATM network 451. At a second ATM switch 455 a second small form-factor module 456 terminates the ATM layer and reconstitutes the TDM bit-stream that is sent to a second TDM link 457.

In a seventh embodiment, Ethernet traffic is transported across an MPLS network. A first small form-factor transceiver module is plugged into a suitable port of a first MPLS Label Switched Router (LSR) connected to an MPLS network, and a second small form-factor transceiver module is plugged into a suitable port of a second LSR connected to the same MPLS network. Both small form-factor receive Ethernet traffic in any of the physical formats in which Ethernet may be delivered (including 10 Mbit/s, 100 Mbit/s, 1 Gbit/s, fiber-optic or copper links). The Ethernet frames are extracted from whatever physical layer over which they are provided, and encapsulated according to ITU-T Recommendation Y.1415 or similar Ethernet pseudowire specifications for tunneling across the MPLS network.

FIG. 4g depicts the use of a small form-factor module with protocol translation for transport of Ethernet over an MPLS network (Ethernet pseudowire). A first small form-factor module 463 in a first MPLS LSR 462 encapsulates Ethernet frames from a first Ethernet link 464 and tunnels them across MPLS network 462. At a second LSR 465 a second small form-factor module 466 decapsulates the MPLS packet, retrieving Ethernet frames that are sent to a second Ethernet link 467.

In a variation of the seventh embodiment, multiple LSRs on the same MPLS network all feed small form-factor modules of the type described. By adding bridging functionality at each LSR, a Virtual Private Network (VPN) implementing Virtual Private LAN Service (VPLS) may be formed.

FIG. 4h depicts a Virtual Private LAN Service (VPLS) supported by small form-factor modules that interconnect Ethernet links 472, 473, 474, and 475 through the use of MPLS network 471.

It will be clear to those versed in the art that other embodiments consisting of different input and/or output formats are possible, and that the embodiments herein specified are only for exemplification of the principles involved and are not intended to limit the scope of the invention to the specific embodiments given.

We claim:

1. A small form-factor transceiver module adapted to transfer electrical or optical transmissions between networks comprising: means for connecting to a network element on a primary network, means for feeding a secondary network or link, and means for providing protocol translation between the protocol of the primary network and that of the secondary network or link.

2. A small form-factor transceiver module of claim 1, wherein said means for providing protocol translation includes an integral protocol translation unit that performs conversion between said network protocols.

3. A small form-factor transceiver module of claim 1 wherein said transceiver conforms to one of the Small Form Factor (SFF) Multisource Agreement, the Small Form Factor Pluggable (SFP) Multisource Agreement, or the Gigabit Interface Converter (GBIC) Specification.

4. A small form-factor transceiver module of claim 1, further including means for enabling transport of traffic from limited-range primary networks over long-range secondary networks or links.

5. A small form-factor transceiver module of claim 4, wherein said long-range links are serial or Time Domain Multiplex (TDM) links selected from the group consisting of N*64K, T1 (1.544 Mbit/s), E1 (2.048 Mbit/s), T3 (44.736 Mbit/s) and E3 (34.368 Mbit/s) links, per ITU-T Recommendation G.703.

6. A small form-factor transceiver module of claim 5, wherein said TDM links are either unstructured or with any level of structure, including framing and channelization per ITU-T Recommendations G.704 or G.751.

7. A small form-factor transceiver module of claim 6 wherein said structured TDM links are one of fractional T1 and fractional E1 links.

8. A small form-factor transceiver module of claim 4, wherein said long-range networks are selected from Synchronous Optical Network (SONET) networks per ANSI T1 standard T1.105, Synchronous Digital Hierarchy (SDH) networks, per ITU-T Recommendation G.707.

9. A small form-factor transceiver module of claim 4, wherein said limited-range primary networks are Ethernet networks, conforming to one of the DIX version 2 and IEEE 802.3 standards.

10. A small form-factor transceiver module per claim 5 wherein said limited-range primary networks are Ethernet networks, conforming to one of the DIX version 2 and IEEE 802.3 standards, and wherein Ethernet frames are translated into a TDM bit-stream using encoding selected from the group consisting of High Level Data-link Control (HDLC) encoding, Ethernet over Link Access Procedure—SDH (LAPS) encoding per one of ITU-Recommendations X.86/Y.1323 and X.85/Y.1321, and Generic Framing Procedure (GFP) encoding per ITU-Recommendation G.7041/Y.1303.

11. A small form-factor transceiver module of claims 8, wherein said limited-range primary networks are Ethernet networks, conforming to one of the DIX version 2 and IEEE 802.3 standards, and wherein Ethernet frames are translated into a SONET/SDH bit-stream using encoding selected from the group consisting of Packet over SONET (POS) encoding per IETF RFC 2615, LAPS encoding per one of ITU-Recommendations X.86/Y.1323 and X.85/Y.1321, and GFP encoding per ITU-T Recommendation G.7041/Y.1303.

12. A small form-factor transceiver module of claim 1, wherein said means for providing protocol translation enables network interworking between different networks of differing technologies.

13. A small form-factor transceiver module of claim 12, wherein the primary network is a packet switched network selected from the group consisting of Ethernet, Internet Protocol (IP) and Multi-Protocol Label Switching (MPLS) networks.

14. A small form-factor transceiver module of claim 12, wherein the primary network is selected from the group consisting of Asynchronous Transfer Mode (ATM) and frame-relay networks.

15. A small form-factor transceiver module of claim 12, wherein the primary network is a SONET/SDH network.

16. A small form-factor transceiver module of claim 12, wherein the secondary network or link is selected from the group consisting of Ethernet and IP 15 networks or links.

17. A small form-factor transceiver module of claim 12, wherein the secondary network is selected from the group consisting of ATM and frame-relay networks.

18. A small form-factor transceiver module of claim 12, wherein the secondary network or link is a TDM network or link.

19. A small form-factor transceiver module of claim 12, wherein the secondary network or link is one of a HDLC and Point-to-Point Protocol (PPP) link.

20. A small form-factor transceiver module of claim 13, wherein the secondary network is selected from the group consisting of ATM and frame-relay networks, and wherein ATM cells from the secondary network or link are encapsulated into MPLS packets in the primary network according to one of ITU-T Recommendations Y.1411 and Y.1412, or similar ATM pseudowire standards.

21. A small form-factor transceiver module of claim 13, wherein the secondary network is selected from the group consisting of ATM and frame-relay networks and wherein frame-relay frames from the secondary network or link are encapsulated into MPLS packets in the primary network according to ITU-T Recommendation X.84 or similar frame-relay pseudowire standards.

22. A small form-factor transceiver module of claim 13, wherein the secondary network or link is one of a HDLC and Point-to-Point Protocol (PPP) link and wherein HDLC or PPP frames from the secondary network or link are encapsulated into MPLS packets in the primary network by detection of non-idle data, removal of bit or byte stuffing, and pseudowire encapsulation.

23. A small form-factor transceiver module of claim 15, wherein the secondary network or link is selected from the group consisting of Ethernet and IP networks or links and wherein Ethernet frames from the secondary network or link are adapted to SONET/SDH for the primary network using encoding selected from the group consisting of POS encoding per IETF RFC 2615, LAPS encoding per ITU-Recommendation X.86/Y.1323 or X.85/Y.1321, and GFP encoding per ITU-T Recommendation G.7041/Y.1303.

24. A small form-factor transceiver module of claim 14, wherein the secondary network or link is selected from the group consisting of Ethernet and IP networks or links and wherein Ethernet frames from the secondary network or link are encapsulated into ATM cells in the primary network using ATM Adaptation Layer Type 5 (AAL5) per ITU-Recommendation I.363.1.

25. A small form-factor transceiver module of claim 14, wherein the secondary network or link is a TDM network or link and wherein TDM segments from the secondary network or link are encapsulated into ATM cells in the primary network using one of ATM Adaptation Layer Type 1 (AAL1) per ITU-Recommendation I.363.1 or ATM Adaptation Layer Type 2 (AAL2) per ITU-Recommendation I.363.2.

26. A small form-factor transceiver module of claim 13, wherein the secondary network or link is a TDM network or link and wherein TDM from the secondary network or link is encapsulated into packets in the primary network by one of ITU-Recommendation Y.1413 subclause 9.1, IETF Structure Agnostic TDM over Packet (SAToP), ITU-T Recommendation Y.1413 subclause 9.2.1 or 9.2.2, IETF TDM over IP (TDMoIP), Circuit Emulation Service over Packet Switched Network (CESoPSN), ITU-Recommendation Y.1414, or similar TDM pseudowire standards.

27. A small form-factor transceiver module of claim 13, wherein the secondary network or link is a TDM network or link and wherein Ethernet frames are encapsulated into MPLS packets per ITU-T Recommendation Y.1415 or similar Ethernet pseudowire standards.

28. A Virtual Private Wire Service (VPWS) or Virtual Private LAN Service (VPLS) provided via the small form-factor transceiver modules of claim 27.
